(19) United States
(12) Patent Application Publication
(10) Pub. No.: US 2011/0187648 A1
(43) Pub. Date: Aug. 4, 2011

(54) HANDHELD ELECTRONIC DEVICE

(75) Inventors: SHENG-CHIA HSU, TAIPEI COUNTY (TW); CHI-HSIUNG LIN, TAIPEI COUNTY (TW); MING-SHU LIN, TAIPEI COUNTY (TW)

(73) Assignees: INVENTEC APPLIANCES (SHANGHAI) CO. LTD., Shanghai (CN); INVENTEC APPLIANCES CORP., Taipei County (TW)

(21) Appl. No.: 12/951,389

(22) Filed: Nov. 22, 2010

(30) Foreign Application Priority Data
Feb. 4, 2010 (CN) 201010113694.1

(51) Int. Cl. G06F 3/02; G06F 3/041

(52) U.S. Cl. 345/168; 345/173

(57) ABSTRACT

A handheld electronic device includes a casing, a touch panel, a display and a controller. Either one of the display and the touch panel is fixed onto the casing. The other one of the display and the touch panel is movably coupled to the casing and disposed above the casing or at the exterior of the casing. The controller is installed in the casing and electrically coupled to the touch panel and the display. The operation of the handheld electronic device depends on the positional relation between the display and the touch panel. While maintaining the operation and viewing quality, the cost and the level of complexity of the design of the handheld electronic device can be reduced to improve the product competitiveness effectively.

### BACKGROUND OF THE INVENTION

1. Field of the Invention

The present invention relates to a handheld electronic device, and more particularly to a handheld electronic device having a movable display or touch panel.

2. Description of the Related Art

Smart handheld electronic devices available in the market are divided into two main types according to their external looks and functions. One type of smart handheld electronic devices uses requirements of multimedia functions as the basis for its design, so that the display of the smart handheld electronic devices of this type occupies much space. Another type of smart handheld electronic devices uses requirements of logging on a network or sending/receiving an email as the basis for its design, so that the smart handheld electronic devices of this type usually come with a standard keyboard to facilitate entering data by users.

In general, models with the advantages of both types of smart handheld electronic devices are available in the market. In other words, these models include a two-layer structure with a touch panel at an upper layer and a standard keyboard at a lower layer. To avoid a too-large volume of the handheld electronic devices, the sizes of both touch panel and standard keyboard are taken into consideration. Since the standard keyboard installed at the lower layer requires an embedded controller, therefore the thickness of the smart handheld electronic device is generally too large. In addition, the two-layer structured smart handheld electronic device requires installations of a controller of the touch panel and a controller of the standard keyboard for controlling the touch panel and the standard keyboard respectively. The controller of the touch panel and the controller of the standard keyboard may interfere with one another due to a mis-trigger made by the users. Furthermore, if the smart handheld electronic device includes the controller of the touch panel and the controller of the standard keyboard, the level of difficulty for the design to pass both drop test and stress test is increased significantly, and the manufacturing cost is increased correspondingly.

Although some smart handheld electronic devices come with no standard keyboard, the touch panel displays a virtual keyboard provided for users to operate the handheld electronic devices and enter data directly by a touch control method. However, the area of a display surface of the touch panel is constant, so that when the display surface displays the virtual keyboard and a user enters data at the same time, the size of the virtual keyboard and the area provided for entering data will be limited. Furthermore, the user has to touch the touch panel to perform an operation, and thus the touch panel may suffer the problems from fingerprints and oil stains on the display and result in a poor vision, and the user has to wipe the touch panel frequently. Obviously, such application is inconvenient.

### SUMMARY OF THE INVENTION

In view of the aforementioned shortcomings of the prior art, it is a primary objective of the invention to provide a handheld electronic device capable of maintaining the operation and viewing quality, avoiding a too-large overall volume of the electronic device, and preventing interferences between controllers caused by a mis-trigger made by users.

To achieve the foregoing objectives, the present invention provides a handheld electronic device comprising a casing, a touch panel, a display and a controller. Either one of the display and the touch panel is fixed onto the casing. The other one of the display and the touch panel is movably coupled to the casing (either above the casing or at the exterior of the casing). The controller is installed in the casing and electrically coupled to the touch panel and the display.

In accordance with a preferred embodiment of the present invention, the other one selected from the display and the touch panel of the handheld electronic device is slidably coupled to the casing.

In accordance with a preferred embodiment of the present invention, the other one selected from the display and the touch panel of the handheld electronic device is rotably coupled to the casing.

In accordance with a preferred embodiment of the present invention, the controller of the handheld electronic device is provided for generating an executing signal according to a touched position of the touch panel and a keyboard symbol corresponding to the touched position and displayed by the display, when the other one selected from the display and the touch panel is situated above the casing.

In accordance with a preferred embodiment of the present invention, the touch panel of the handheld electronic device is fixed onto the casing, and the display is movably coupled to the casing and includes a graphic surface aligned towards the touch panel and a plurality of keyboard symbols, and the controller is provided for generating an executing signal according to a touched position of the touch panel and a keyboard symbol corresponding to the touched position, when the display is situated at the exterior of the casing.

In accordance with a preferred embodiment of the present invention, the touch panel of the handheld electronic device is fixed onto the casing, and the display is movably coupled to the casing, and the handheld electronic device further comprises: a light emitting element, installed at the casing, for producing a light; and a fluorescence excitation layer, installed on a surface of the touch panel, and including a plurality of keyboard symbols, for producing another light when the light is received, wherein if the display is situated at the exterior of the casing, and the light emitting element is enabled, the controller is provided for generating an executing signal according to a touched position of the touch panel and a keyboard symbol corresponding to the touched position.

In accordance with a preferred embodiment of the present invention, the light emitting element of the handheld electronic device is disposed on a lateral edge of the touch panel.

In accordance with a preferred embodiment of the present invention, the display of the handheld electronic device is fixed onto the casing, and the touch panel is movably coupled to the casing, and the handheld electronic device further comprises: a light emitting element, for producing a light; and a first light guide module, installed in the touch panel, for guiding the light to show a keyboard symbol on the touch panel, such that if the touch panel is situated at the exterior of the casing, and the light emitting element is enabled, the controller is provided for generating an executing signal according to a touched position of the touch panel and the keyboard symbol corresponding to the touched position.

In accordance with a preferred embodiment of the present invention, the handheld electronic device further comprises: a second light guide module, installed in the touch panel, for guiding the light to display another keyboard symbol on the touch panel, such that if the touch panel is situated at the exterior of the casing, and the light emitting element is enabled, the controller is provided for generating an executing signal according to another touched position of the touch panel and this another keyboard symbol corresponding to the other touched position.

In accordance with a preferred embodiment of the present invention, the controller of the handheld electronic device is provided for transmitting a display signal to the display according to at least one touched position of the touch panel, such that the display can display a corresponding image according to the display signal.

The present invention can achieve the effects of maintaining the operation and viewing quality, avoiding a too-large overall volume, and preventing interferences between controllers caused by a mis-trigger made by users to improve the convenience of the user's operation, and reduce the cost and the level of complexity of the design, so as to enhance the product competitiveness of the handheld electronic device of the present invention effectively.

### BRIEF DESCRIPTION OF THE DRAWINGS

FIG. 1 is an exploded view of a handheld electronic device in accordance with a first preferred embodiment of the present invention;

FIG. 2A is a schematic view of a display as depicted in FIG. 1 situated above a casing when the handheld electronic device is assembled;

FIG. 2B is a schematic view of a display as depicted in FIG. 1 situated at the exterior of a casing when the handheld electronic device is assembled;

FIG. 3 is a block diagram of the handheld electronic device as depicted in FIG. 1;

FIG. 4A is a schematic view of a handheld electronic device in accordance with a second preferred embodiment of the present invention;

FIG. 4B is a block diagram of the handheld electronic device as depicted in FIG. 4A;

FIG. 5A is a schematic view of a touch panel disposed above a casing in accordance with a third preferred embodiment of the present invention;

FIG. 5B is a schematic view of a touch panel as depicted in FIG. 5A disposed at the exterior of the casing;

FIG. 5C is a block diagram of a handheld electronic device as depicted in FIG. 5A;

FIG. 6A is a schematic view of a keyboard symbol shown by a first light guide module; and

FIG. 6B is a schematic view of another keyboard symbol shown by a second light guide module.

### DETAILED DESCRIPTION OF THE PREFERRED EMBODIMENTS

The present invention discloses a handheld electronic device comprising a casing, a touch panel, a display and a controller. Either one of the display or the touch panel is fixed onto the casing. The other one of the display or the touch panel is movably coupled to casing, and situated above the casing or at the exterior of the casing. The controller is installed in the casing and electrically coupled to the touch panel and the display. The following preferred embodiments together with related drawings are used for describing and illustrating a handheld electronic device of the present invention, and these preferred embodiments and drawings are provided for the illustration purpose only, but not intended for limiting the scope of the present invention.

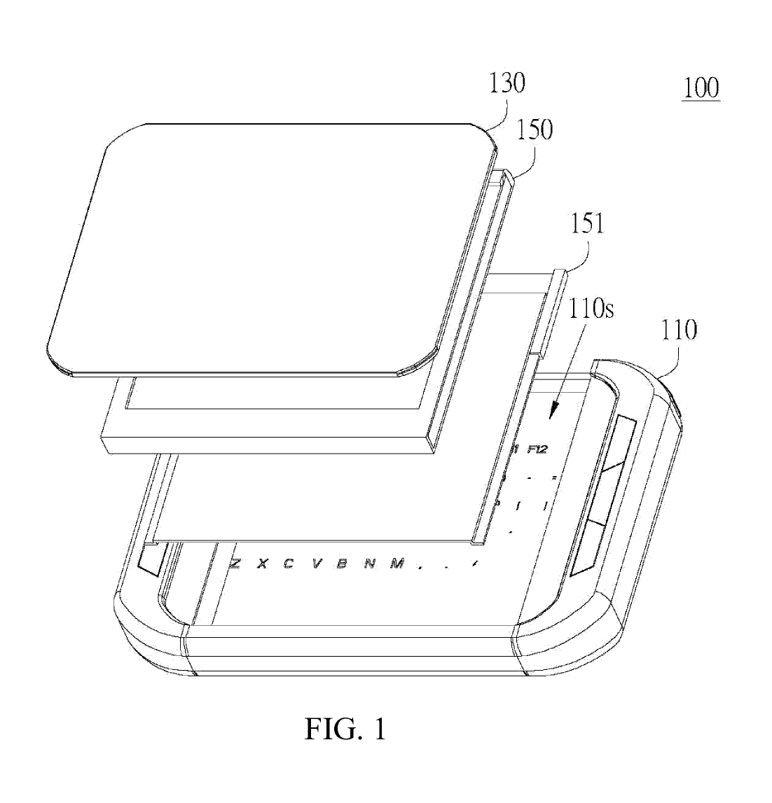

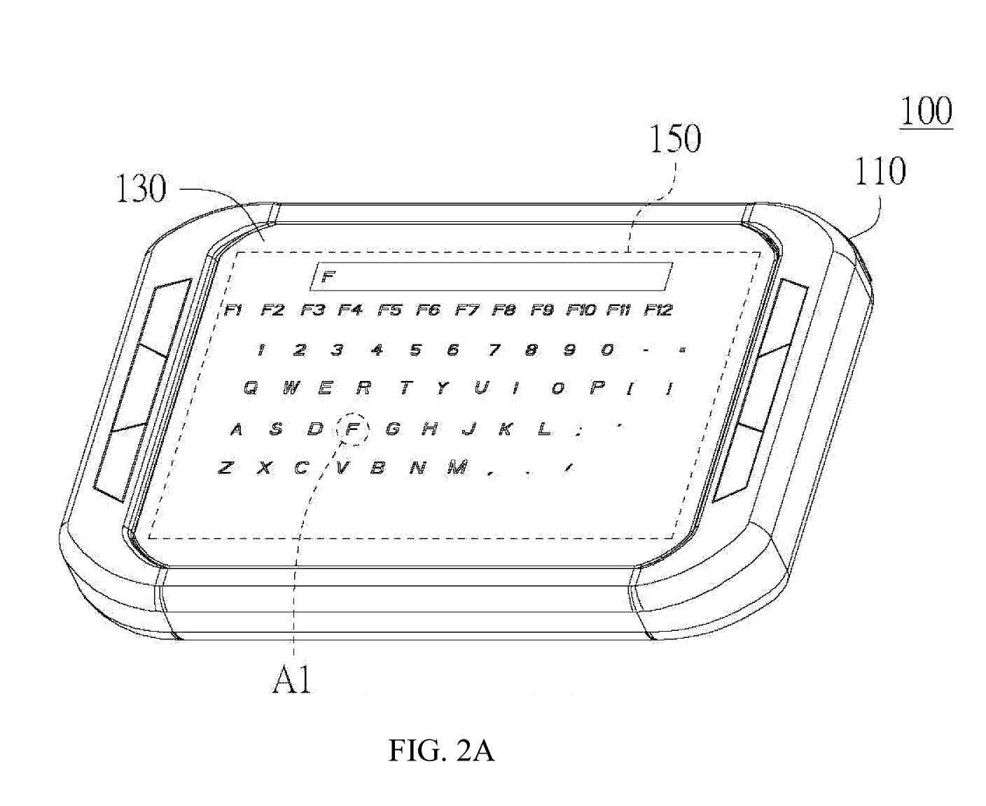

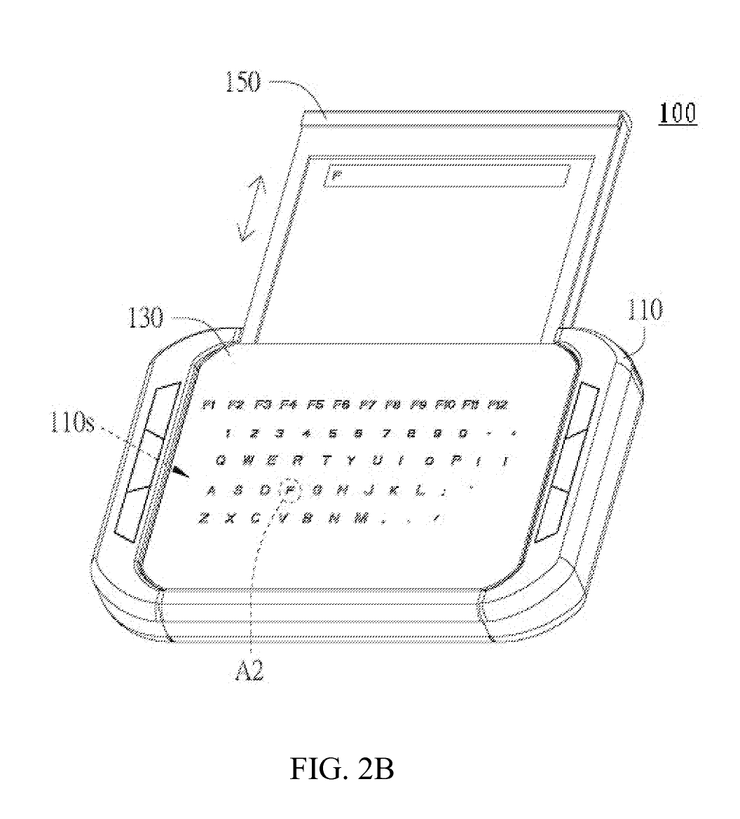

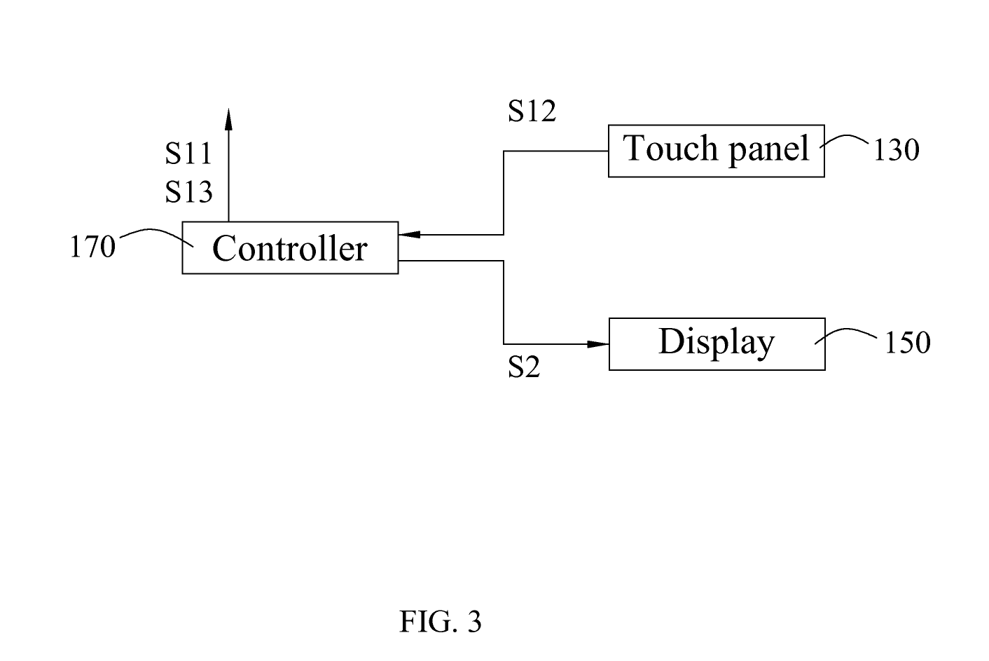

In a first preferred embodiment, the touch panel is fixed onto the casing, and the display is movably coupled to the casing. With reference to FIGS. 1, 2A, 2B and 3, FIG. 1 is an exploded view of a handheld electronic device in accordance with the first preferred embodiment of the present invention, and FIG. 2A is a schematic view of a display of FIG. 1 situated above the casing when the handheld electronic device is assembled, and FIG. 2B is a schematic view of a display of FIG. 1 situated at the exterior of the casing when the handheld electronic device is assembled, and FIG. 3 is a block diagram of the handheld electronic device.

The handheld electronic device 100 such as a smart mobile device comprises a casing 110, a touch panel 130, a display 150 and a controller 170. The touch panel 130 is fixed onto the casing 110. The display 150 is movably coupled to the casing 110. Therefore, the display 150 can be situated above the casing 110 as shown in FIG. 2A. More specifically, the display 150 and the touch panel 130 are installed sequentially on the casing 110 as shown in FIG. 2A. Alternatively, the display 150 can be situated at the exterior of the casing 110 as shown in FIG. 2B. In this preferred embodiment, the display 150 can be slidably coupled to the casing 110 by a slide element 151. Therefore, the display 150 can be slid with respect to the casing 110 by the slide element 151 and situated above the casing 110 or at the exterior of the casing 110.

The controller 170 is installed in the casing 110 and electrically coupled to the touch panel 130 and the display 150. In this preferred embodiment, the controller 170 can be operated according to the position of the display 150 relative to the touch panel 130 as described below.

In FIG. 2A, the display 150 displays a plurality of keyboard symbols. When the display 150 is situated above the casing 110 (in other words, at the bottom the touch panel 130), a user can see the keyboard symbol displayed by the display 150 through the transparent touch panel 130. The controller 170 generates an executing signal S11 according to the touched position A1 of the touch panel 130 and the keyboard symbol is displayed on the display 150 and corresponding to the touched position A1. In other words, the touch panel 130 generates and transmits a touch signal S12 to the controller 170 according to the touched position A1, so that the touched position A1 is determined according to the touch signal S12 by the controller 170. For example, the touched position A1 shown in the figure corresponds to a keyboard symbol “F” displayed by the display 150, so that the controller 170 generates a corresponding executing signal S11 to drive the display 150 to show the character “F”.

In FIGS. 1 and 2B, the casing 110 has a graphic surface 110s. The graphic surface 110s can be formed by carving. The graphic surface 110s is aligned towards the touch panel 130 and includes a plurality of keyboard symbols. When the display 150 is situated at the exterior of the casing 110, a user can see the keyboard symbols of the graphic surface 110s disposed under the touch panel 130 through the transparent touch panel 130. The controller 170 generates an executing signal S13 according to the touched position A2 of the touch panel 130 and the keyboard symbol corresponding to the touched position A2. For example, the touched position A2 as shown in the figure corresponds to the keyboard symbol “F” on the graphic surface 110s, so that the controller 170 generates a corresponding executing signal S13 to drive the display 150 to show the character “F”.

The touch panel 130 can be a capacitive touch panel. Therefore, the controller 170 can transmit a display signal S2 to the display 150 according to one or more touched positions of the touch panel 130, such that the display 150 can display a corresponding image according to the received display signal S2. In other words, the touch panel 130 can be a handwriting tablet provided for a user to write on the touch panel 130 in order to enter data. Alternatively, the touch panel 130 can be a drawing board provided for a user to draw on the touch panel 130 to produce pictures. Alternatively, the user can turn pages by sliding on the touch panel 130, or zoom in/out a screen of the display 150 by moving two fingers in opposite directions.

The handheld electronic device with a double-layer structure generally has two controllers provided for a user to operate a standard keyboard and a touch panel. On the other hand, the handheld electronic device 100 of this preferred embodiment uses a controller 170 to achieve the same function as the conventional way of using two controllers to control the standard keyboard and the touch panel for their operation. Therefore, the handheld electronic device 100 with a single-layer structure has a smaller volume, and the handheld electronic device 100 has just one controller 170, and a wrong operation or interferences between the two controllers of the conventional handheld electronic device can be avoided. Compared with the conventional handheld electronic device that requires a protection design for the two controllers, the handheld electronic device 100 simply requires a design to pass the drop test and the stress test of the controller 170, so as to reduce the manufacturing cost and the difficulty of the design. In addition, the display 150 of this preferred embodiment can be moved with respect to the touch panel 130 to the exterior of the casing 110 (as shown in FIG. 2B). Compared with the conventional handheld electronic device that generally requires displaying the virtual keyboard and allowing users to enter data from the same screen, the handheld electronic device 100 of this preferred embodiment provides the keyboard symbols through the graphic surface 110s of the casing 110, such that the display 150 can be used completely for the purpose of displaying the data entered by the users. Even though fingerprints or oil stains may be produced by users on the touch panel 130 of this preferred embodiment, the screen of the display 150 as shown in FIG. 2B will not be affected by the fingerprints and oil stains remained on the displayed screen of the touch panel 130.

The display 150 is slidably coupled to the casing 110 in accordance with this preferred embodiment, but persons ordinarily skilled in the art should understand that the display 150 also can be rotably coupled to the casing 110. Thus, the casing 110 can be situated above the casing 110 or at the exterior of the casing 110 by such rotational arrangement.

In a second preferred embodiment, this preferred embodiment is similar to the first preferred embodiment, wherein the touch panel is fixed onto the casing, and the display is movably coupled to the casing. However, the handheld electronic device of this preferred embodiment allows users to see the keyboard symbols through an optical method when the display is situated at the exterior of the casing, and the details are described as follows.

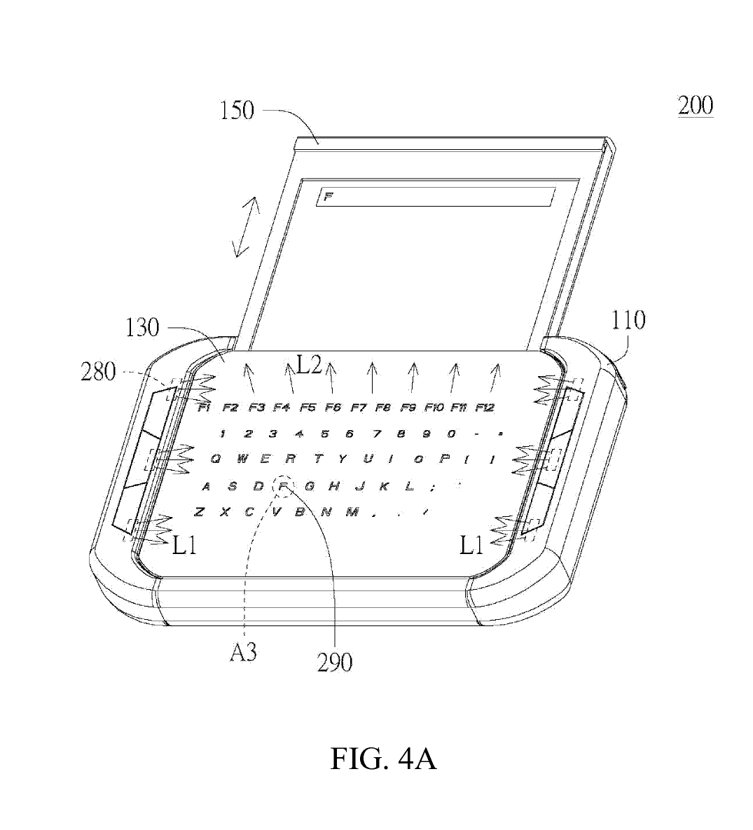

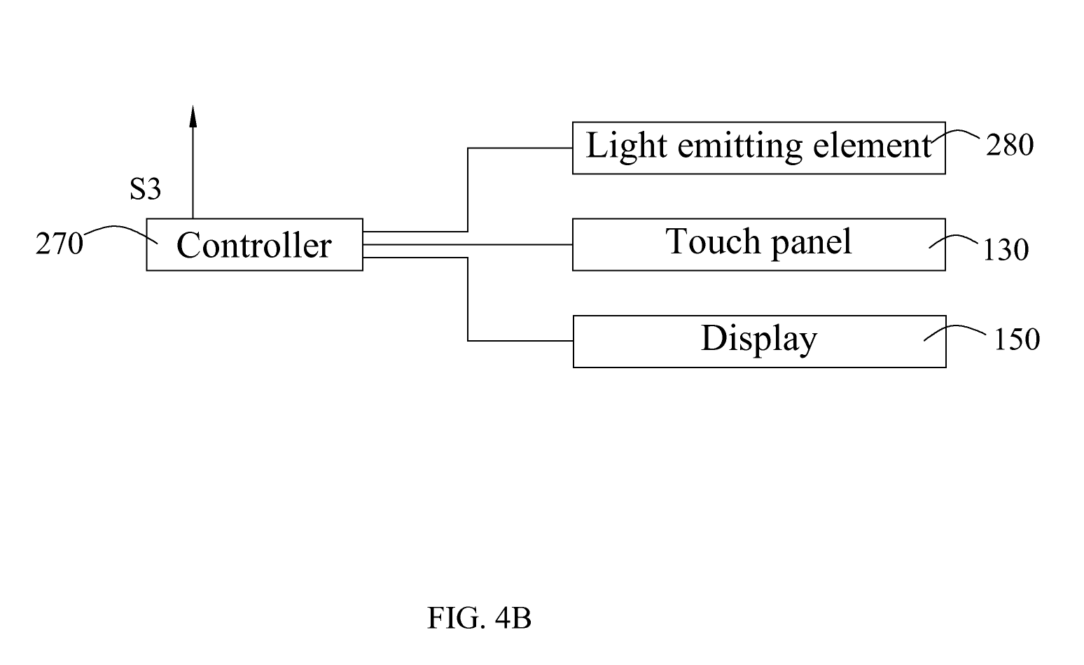

With reference to FIGS. 4A and 4B, FIG. 4A is a schematic view of a handheld electronic device in accordance with a second preferred embodiment of the present invention, and FIG. 4B is a block diagram of the handheld electronic device as depicted in FIG. 4A.

The handheld electronic device 200 comprises a plurality of light emitting elements 280 and a fluorescence excitation layer 290. The light emitting elements 280 are installed at the casing 110, such as at a lateral edge of the touch panel 130. The fluorescence excitation layer 290 is installed on a surface of the touch panel 130. In this preferred embodiment, the fluorescence excitation layer 290 includes a plurality of keyboard symbols printed on a surface of the touch panel 130 and made of a fluorescent material. The light emitting elements 280 produce light L1. When the fluorescence excitation layer 290 made of fluorescent material receives the light L1 from the light emitting elements 280, electrons are excited to a high energy level state. When the electrons return to the original low energy level state from the high energy level state, energy in form of light is released. In other words, light L2 is produced, so that users can see the keyboard symbols clearly.

The controller 270 is installed in the casing 110 and electrically coupled to the touch panel 130, the display 150 and the light emitting element 280. If the light emitting elements 280 are operated by a user or enabled automatically to emit a light, the user will be able to see the keyboard symbols displayed by the fluorescence excitation layer 290. If the display 150 is situated at the exterior of the casing 110, the controller 270 will generate an executing signal S3 according to a touched position A3 of the touch panel 130 and a keyboard symbol corresponding to the touched position A3. The touched position A3 of this embodiment corresponds to the keyboard symbol “F” of the fluorescence excitation layer 290, so that the controller 270 generates the corresponding executing signal S3 to drive the display 150 to display the character “F”. Therefore, the handheld electronic device 200 of this preferred embodiment can have the advantages similar to those of the handheld electronic device 100 of the first preferred embodiment.

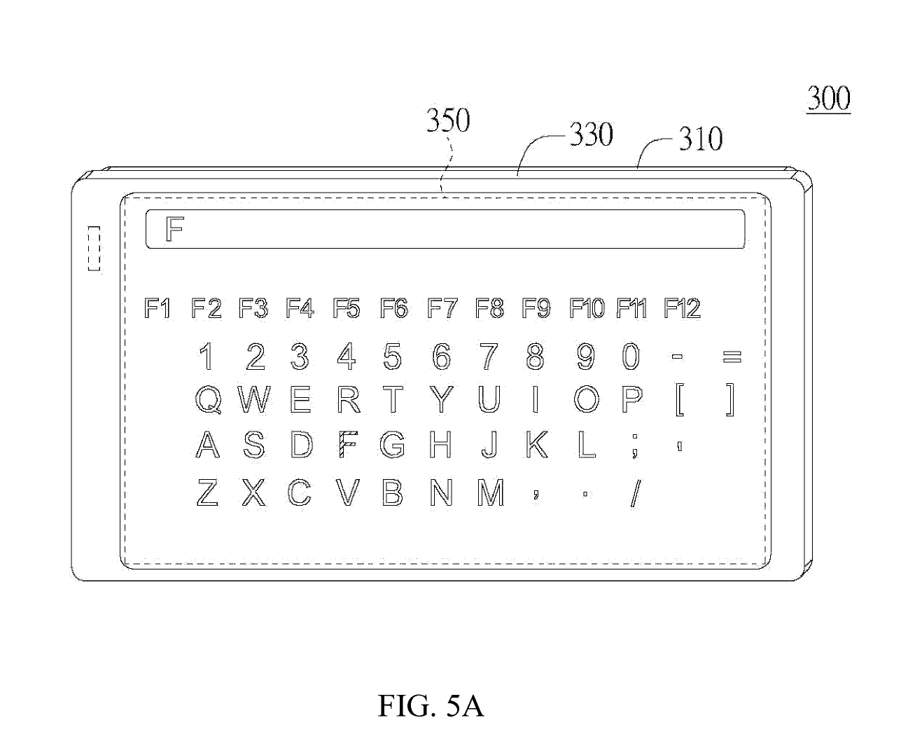

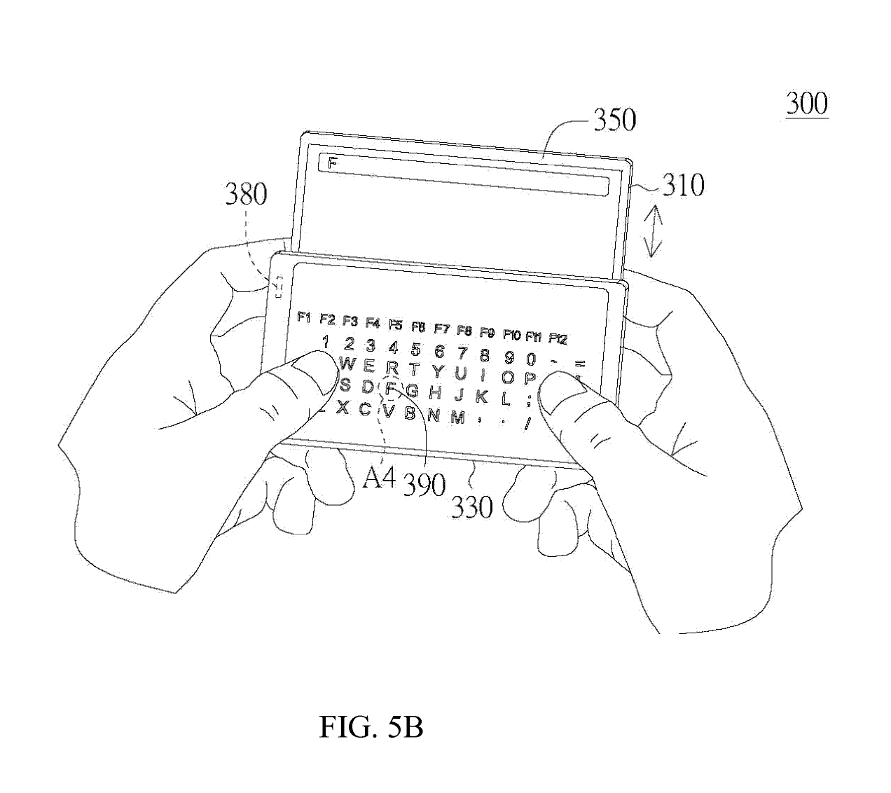

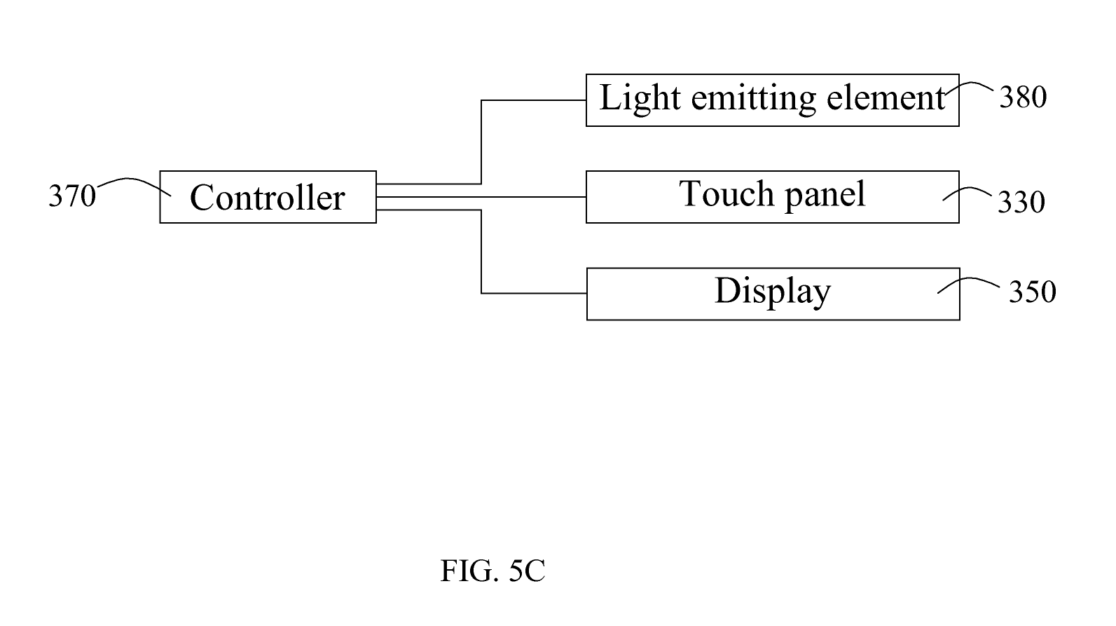

In a third preferred embodiment, this preferred embodiment is similar to the first preferred embodiment, wherein the touch panel is fixed onto the casing, and the display is movably coupled to the casing. With reference to FIGS. 5A-5C, FIG. 5A is a schematic view showing a touch panel situated above a casing in accordance with the third preferred embodiment of the present invention, FIG. 5B is a schematic view showing the touch panel of FIG. 5A situated at the exterior of the casing, and FIG. 5C is a block diagram of the handheld electronic device as depicted in FIG. 5A.

The handheld electronic device 300 comprises a casing 310, a touch panel 330, a display 350 and a controller 370. The display 350 is fixed onto the casing 310. The touch panel 330 is movably coupled to the casing 310. Therefore, the touch panel 330 can be situated above the casing 310 as shown in FIG. 5A. More specifically, the display 350 and the touch panel 330 are installed sequentially onto the casing 310 as shown in FIG. 5A, or the touch panel 330 can be situated at the exterior of the casing 310 as shown in FIG. 5B.

The controller 370 is installed in the casing 310 and electrically coupled to the touch panel 330 and the display 350. In this preferred embodiment, the controller 370 determines an operating method according to relative positions of the display 350 and the touch panel 330. The details are described as follows.

In FIG. 5A, if the touch panel 330 is situated above the casing 310, the relative positions of the touch panel 330, the display 350 and the casing 310 of the handheld electronic device 300 are similar to the relative positions of the touch panel 130, the display 150 and the casing 110 of the handheld electronic device 100 as shown in FIG. 2A. Therefore, the operation of the controller 370 of this preferred embodiment as shown in FIG. 5A is similar to the operation of the controller 170 of the first preferred embodiment.

The handheld electronic device 300 further comprises a light emitting element 380 and a first light guide module 390. For example, the light emitting element 380 of the light emitting diode is installed at the touch panel 330 for producing a light. For example, the first light guide module 390 made of optical fibers is installed in the transparent touch panel 330 made of tempered glass. The first light guide module 390 is provided for guiding the light to display the keyboard symbols on the touch panel 330, so that users can see the keyboard symbols.

If the light emitting element 380 is operated by a user or enabled automatically to emit a light, the users can see the keyboard symbols displayed on the touch panel 330 by the first light guide module 390. If the touch panel 330 is situated at the exterior of the casing 310, the controller 370 will generate an executing signal according to a touched position A4 of the touch panel 330 and a keyboard symbol corresponding to the touched position A4. The touched position A4 in this preferred embodiment corresponds to a keyboard symbol “F” formed on a surface of the touch panel 330 by the first light guide module 390. Therefore, the controller 370 generates the corresponding executing signal to drive the display 350 to display the character “F”. The handheld electronic device 300 of this preferred embodiment has the advantages similar to those of the handheld electronic device 100 of the first preferred embodiment.

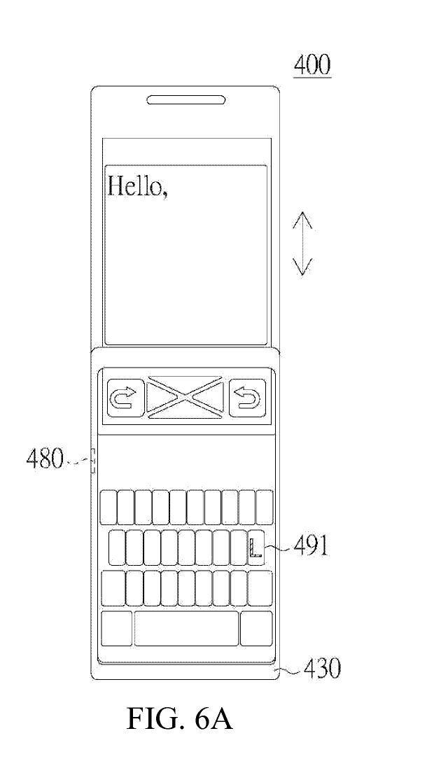

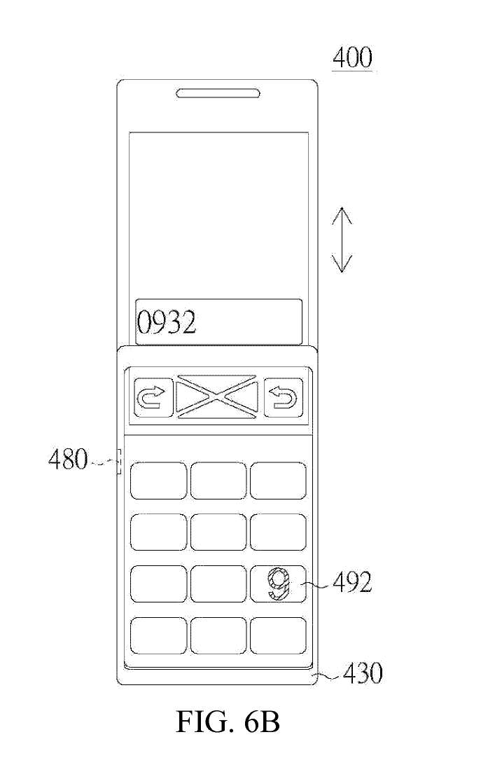

Compared with the third preferred embodiment, a handheld electronic device of a fourth preferred embodiment comprises two light guide modules for displaying keyboard symbols with different installation methods. With reference to FIGS. 6A and 6B, FIG. 6A is a schematic view showing a keyboard symbol displayed by a first light guide module, and FIG. 6B is a schematic view showing another keyboard symbol displayed by a second light guide module.

The handheld electronic device 400 comprises a light emitting element 480, a first light guide module 491 and a second light guide module 492. The light emitting element 480 is installed at the touch panel 430, and provided for producing a light. The first light guide module 491 and the second light guide module 492 are installed in the touch panel 430. The first light guide module 491 and the second light guide module 492 are provided for guiding the light to display different keyboard symbols on the touch panel 430. For example, the first light guide module 491 as shown in FIG. 6A is used for guiding the light produced by the light emitting element 480 to display alphabetic keyboard symbols on the touch panel 430. In addition, the second light guide module 492 as shown in FIG. 6B is used for guiding the light produced by the light emitting element 480 to display numeral keyboard symbols on the touch panel 430.

In addition to the advantages similar to those of the handheld electronic device 100 of the first preferred embodiment, the handheld electronic device 400 of this preferred embodiment also provides a flexible operation by means of the first light guide module 491 and the second light guide module 492 having different keyboard symbols. Compared with the handheld electronic devices that can be operated and viewed transversally in accordance with the first to third preferred embodiments, the handheld electronic device 400 of this preferred embodiment is a device that is operated and viewed vertically. Of course, the handheld electronic devices of the first to third preferred embodiments can be changed, such that it can be operated and viewed vertically.

As disclosed in the handheld electronic device in accordance with the foregoing preferred embodiments of the present invention, either one of the display and the touch panel is fixed onto the casing, and the other one of the display and the touch panel is movably coupled to the casing, so that the operation of the handheld electronic device depends on the positional relation between the display and the touch panel. Therefore, the handheld electronic device of the foregoing preferred embodiments can reduce the cost and the level of complexity of the design while maintaining the quality of operation and viewing of the handheld electronic device, so as to improve the product competitiveness effectively.

In summation of the description above, the present invention can improve over the prior art and comply with the patent application requirements, and thus the invention is duly filed for patent application.

While the invention has been described by device of specific embodiments, numerous modifications and variations could be made thereto by those generally skilled in the art without departing from the scope and spirit of the invention set forth in the claims.

What is claimed is:

1. A handheld electronic device, comprising:
a casing;
a touch panel;
a display, one of the display and the touch panel being fixed onto the casing, and the other being movable coupled to the casing so as to be disposed at the exterior of the casing or above the casing; and
a controller, installed in the casing, and electrically coupled to the touch panel and the display.

2. The handheld electronic device of claim 1, wherein the display or the touch panel being movable coupled to the casing is slidably coupled to the casing.

3. The handheld electronic device of claim 1, wherein the display or the touch panel being movable coupled to the casing is rotably coupled to the casing.

4. The handheld electronic device of claim 1, wherein when the display or the touch panel being movable coupled to the casing is disposed above the casing, the controller is used for generating an executing signal according to a touched position of the touch panel and a keyboard symbol displayed on the display corresponding to the touched position.

5. The handheld electronic device of claim 1, wherein the touch panel is fixed onto the casing, and the display is movably coupled to the casing, and the casing includes a graphic surface aligned towards the touch panel, the graphic surface includes a plurality of keyboard symbols, and when the display is disposed at the exterior of the casing, the controller is used for generating an executing signal according to a touched position of the touch panel and the keyboard symbol corresponding to the touched position.

6. The handheld electronic device of claim 1, wherein the touch panel is fixed onto the casing, and the display is movably coupled to the casing, and the handheld electronic device further comprises:
a light emitting element, disposed in the casing, for generating a light; and
a fluorescence excitation layer, formed on a surface of the touch panel, and including a plurality of keyboard symbols, and provided for generating another light when the light is received, such that when the display is disposed at the exterior of the casing and the light emitting element is enabled, the controller is provided for generating an executing signal according to a touched position of the touch panel and the keyboard symbol corresponding to the touched position.

7. The handheld electronic device of claim 6, wherein the light emitting element is disposed at one edge of the touch panel.

8. The handheld electronic device of claim 1, wherein the display is fixed onto the casing, and the touch panel is movably coupled to the casing, and the handheld electronic device further comprises:
a light emitting element, for generating a light; and
a first light guide module, disposed in the touch panel, for guiding the light to display a first keyboard symbol on the touch panel, such that when the touch panel is disposed at the exterior of the casing and the light emitting element is enabled, the controller is provided for generating a first executing signal according to a first touched position of the touch panel and the first keyboard symbol corresponding to the first touched position.

9. The handheld electronic device of claim 8, further comprising a second light guide module, disposed in the touch panel, for guiding the light to display a second keyboard symbol on the touch panel, such that if the touch panel is disposed at the exterior of the casing and the light emitting element is enabled, the controller is provided for generating a second executing signal according to a second touched position of the touch panel and the second keyboard symbol corresponding to the second touched position.

10. The handheld electronic device of claim 1, wherein the controller is provided for transmitting a display signal to the display according to at least one touched position of the touch panel, such that the display displays a corresponding image according to the display signal.
